(19) United States
(12) Patent Application Publication
(10) Pub. No.: US 2017/0118626 A1
(43) Pub. Date: Apr. 27, 2017

(54) DYNAMICALLY MANAGING SUBSCRIPTIONS FOR PORTABLE COMPUTING DEVICE HARDWARE ACCESS

(71) Applicant: Rajendra P. Sadhu, Somerset, NJ (US)

(72) Inventor: Rajendra P. Sadhu, Somerset, NJ (US)

(21) Appl. No.: 15/397,417

(22) Filed: Jan. 3, 2017

Related U.S. Application Data
(63) Continuation-in-part of application No. 14/025,475, filed on Sep. 12, 2013, now Pat. No. 9,545,230.
Application No. 14/025,475 is a continuation-in-part of application No. 13/105,925, filed on May 12, 2011, now Pat. No. 8,568,313.
Application No. 13/105,925 is a continuation-in-part of application No. 12/722,554, filed on Mar. 12, 2010.

(51) Int. Cl. H04W 8/18; H04W 4/00; H04W 48/18; H04W 8/22

(52) U.S. Cl. CPC H04W 8/183; H04W 8/22; H04W 4/001; H04W 48/18

(57) ABSTRACT

The present disclosure relates to methods and systems for accessing at least one subscription level by a portable communication device (PCD), wherein the subscription plan processing module transmits its unique identifier (UID) to a subscription server, subscription plan receiving module receives a subscription plan that corresponds to the UID from the server, and subscription plan processing module activates/deactivates the status of one or more selectably actuable hardware servicing components/sensors to dynamically control flow by at least one gating method.

### CROSS-REFERENCE TO RELATED APPLICATION

This is a Continuation-In-Part application of U.S. patent application Ser. No. 14/025,475, filed Sep. 12, 2013 which is a Continuation of U.S. patent application Ser. No. 13/105,925, filed May 12, 2011, that is now U.S. Pat. No. 8,568,313, which is a Continuation-In-Part of U.S. patent application Ser. No. 12/722,554, filed Mar. 12, 2010, the contents of each of which are hereby incorporated by reference in their entireties.

### FIELD OF THE INVENTION

The present disclosure relates to the field of electronic/portable computing devices. In particular, the present disclosure pertains to a system and method for enabling and disabling one or more hardware components/sensors/features of a portable computing device such as of a mobile phone or smart phone or smart watch based on a subscription chosen/selected by a user of the portable computing device.

### BACKGROUND

The background description includes information that may be useful in understanding the present invention. It is not an admission that any of the information provided herein is prior art or relevant to the presently claimed invention, or that any publication specifically or implicitly referenced is prior art.

Evolution of computing devices such as personal computers and lately smart computing devices such as laptops, smart phones, wearable devices, smart watches, wristbands, tablets has been rapid. A lot of improvement is happening on every aspect of these devices such as software, hardware and/or communication protocols etc. Earlier computing devices and/or configured applications were limited to experimental work, scientific calculations, however now this focus has shifted and presently computing devices are an integral part of daily life of all strata/type/categories of users. A web server or cloud is another vertical that is gaining momentum and allows connected client/computing/communication devices to execute various complex applications for variety of tasks, for example, gaming, motion sensing, healthcare etc. Various kinds of servers such as database servers, game servers, advertisement servers, file servers, mail servers, print servers, web servers, real-time servers (such as Azure from Microsoft) and application servers are available in the market to satisfy diverse client requirements.

FIG. 1 illustrates a user wearable portable communication device (such as a smart watch 100) along with its various components that enable communication between the user wearable portable communication device and a web server/cloud. Computing device 100 includes a processor or micro controller (such as but not limited to Cortex-A Series (A5 and A7) that is coupled with one or more wireless communication module such as but not limited to CDMA/GSM/WCDMA/3G/4G/5G/LTE/Wi-Fi/BlueTooth/ZigBee/Radio Module 102 and/or graphics, audio and video processors, a memory controller 104 to provide an interface to off-chip memories, a display 106, a battery 108, network components 110, sensors 112, an antenna 114, a GPS 116, a codec 118, a speaker 120, a mic 122, a real time clock 124, and a level shifter 126. These components can be arranged either in the band or in the casing or on the casing.

With the number of hardware components and sensors (such as GPS sensor, heart rate measurement sensor, humidity measurement sensor, gyroscope, fall detection sensor, among others) that are configured or are desired to be configured in a portable computing device growing by the day, cost of manufacturing does not increase substantially even with additional sensors that are not in use, tailoring multiple devices (such as phone or smart watches) with such hardware/firmware level features is expensive for manufacturers.

While there are many sensors and features, not all customers require a device with all the sensors and features. Manufacturing multiple versions of the devices and with various combinations of parts is not an option to the manufacturer due to cost of maintaining the inventory and accurately estimating the demand for a particular SKU or model in the market.

People like to either upgrade or downgrade the requirements, features/options they want and replacing the device with a new device is more expensive and time consuming.

Sterilizing the device that is returned by one customer before sending to another customer who has requested or subscribed for the plan could be expensive and prone to legal issues.

Health Information Privacy Protection Act (HIPPA) and many compliance forms may require to monitor only data that customer has agreed for and provided a consent for monitoring.

There is therefore a need for a system that will work as multipurpose device, which enables use of one or more hardware elements/components and/or sensors based on user's subscription to the one or more hardware elements/physical or virtual components/software elements and/or sensors.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY

The present disclosure relates to the field of a electronic/wearable/portable computing/communication device (such as a mobile phone/smart phone/smart watch). In particular, the present disclosure pertains to a system and method for one or more selectably actuable hardware servicing components/sensors/features of a portable computing device such as of a mobile phone or smart phone or smart watch based on a subscription chosen/selected by a user of the portable computing device.

In an aspect, the present disclosure relates to a portable computing device that comprises one or more selectably actuable hardware components/sensors/elements (collectively and interchangeably referred to hardware components or sensors hereinafter) such as but not limited to heart rate monitor, fall detector, blood pressure monitor, modem, magnetometer, gyroscope, accelerometer, GPS, temperature sensor, environment detector, sugar monitoring sensor, among any other like hardware/firmware level component that can be configured in the computing device. Although embodiments of the present disclosure have been explained with reference to smart watch, any other electronic device, portable and/or wearable computing device is well within the scope of the present invention. For example an electronic device inside an automobile or car serving the driver or passenger with specific needs based on the subscription chosen with the subscription service provider.

In an aspect, the present disclosure relates to a system architecture having a server/cloud comprising a memory that is configured to store a plurality of subscriptions (also interchangeably referred to as plans or levels or a combination thereof), each subscription comprising a list of features, subscription offer start date, subscription offer end date, at least one feature will require data from at least one or more hardware elements/components/sensors that are to be activated in the proposed computing device as part of that respective subscription such that when user of a first computing device select a particular subscription/plan, hardware elements/components/sensors that form part of the selected subscription are activated in the first computing device. Once activated, the user can view/set/configure/manage various outputs/parameters/deliverables of the activated hardware elements/components/sensors, and control/operate the same. Each subscription plan can be associated with a defined amount, offer start date, offer end date such that the user can choose an appropriate plan/subscription based on user preference, and even switch from one plan to another.

In an exemplary implementation, the present disclosures relates to subscription plan processing module sending, from an electronic device that can be either user wearable or portable computing device (PCD) or simply an electronic computing device (CD), a unique identifier (UID) associated with the PCD, to a subscription server (also referred to as subscription level server) that is operatively coupled with a plurality of PCD's over one or more networks; subscription plan receiving module, at the PCD, subscription plan to which the PCD is mapped; and activates/deactivates the status of one or more sensors of the PCD based on received subscription plan. Such configuration can include dynamically controlling flow to one or more hardware servicing components by at least one gating method based on details that form part of the subscription. Subscription plan processing/receiving module can be at least one of a logical/software/hardware/mechanical/virtual/physical component inside the PCD.

In an aspect, UID can be International Mobile Equipment Identity (IMEI) number or MEID (Mobile Equipment Identifier) of the PCD (in case the PCD is a mobile/smart phone, for instance) or can be any other unique identifier that can be associated with the PCD either by the manufacturer or by the proposed system. For instance, a PCD can initially register with the server/cloud storing the subscription plans, based on which registration, the server/cloud/system can automatically associate/assign a UID with the PCD based on the pre conditions stored in the software or hardware component or flip flops or integrated circuit in PCD and the conditions may include but not limited to key input parameters like subscriber location, address, age, type of subscription, duration of subscription, type of the PCD, model of the PCD, manufacturing date of the PCD etc.

In an aspect, the server can store details about the subscriber including but not limited to name, address, location, subscription type, duration. Subscription start date, subscription end date, current status or validity of the subscription.

In an aspect, UID can be sent to server by subscription plan processing module using any or combination of short range communication mechanism and long range communication mechanism. Communication protocol being used can be wired or wireless or reading controllable switches or flip flops, all of which possible scenarios are well within the scope of the present disclosure. UID can be encrypted or combined with other key value parameters during the transmission.

In an aspect, it is to be appreciated that the step of configuring/activating/deactivating the one or more sensors of the PCD based on received subscription plan can be implemented at firmware level and cannot be done manually through display interface of the proposed PCD. However, it may be possible for the user to, upon successful registration to the subscription from the PCD, control/configure, say through a settings options, the activated sensors/hardware elements, but the deactivated sensors/hardware elements cannot be activated/reactivated unless there is a change to the subscription level through any such interface, which are activated only at the firmware level based on the subscription plan it received by the PCD from the server.

In an aspect, UID can be stored in a chip (communicatively coupled with a microprocessor/microcontroller), wherein chip can serve as a gateway/bridge/level shifter to various hardware servicing components like but not limited to sensors, hardware components by controlling signals such as but not limited to power signals and data signals to the sensors using a gating method such as but not limited to DC gate, logic gate, power gate, switch, electronic gate, pulsed gate, trigger current, trigger voltage, AC gate, Logical instructions. Upon successful PCD initialization, UID from the chip can be transmitted to server to get the subscription plan/level/status, and upon receiving the subscription response from server, chip can automatically enable/disable the data/power flow to the respective sensors and can minimizes power consumption by disabling the sensors that were not opted.

In an exemplary aspect, sensors/hardware elements of the present invention can be selected from any or a combination of sensors for detecting a fall, heart rate, pulse rate, body temperature, blood sugar, breath rate, Internet availability, location, 9-axis accelerometer measurements, magnetometer measurements, UV level, humidity level, proximity, CO₂ level, blood pressure, environmental conditions/parameters, among other parameters. Hardware components can further be configured for actions such as emergency calls, sending automatic alerts, and enabling Internet services. As explained above, each subscription plan can include one or more sensors/hardware elements that need to be activated under that plan.

In an exemplary aspect of dynamically managing the sensors based on events, selected sensors can be automatically get enabled/activated upon occurrence of certain events/conditions such as pressing of a SOS button, PCD reboot etc. Activated sensor(s) can stay active till the next reboot of the PCD or manual intervention or another occurrence of an event that can disable the one or more activated sensors. PCD can communicate with the server when such event (PCD reboot or manual intervention or disable sensor event) happens so that server can apply additional charges on top of the subscription charges for the duration the additional sensors are actively sensing sensory data and sending them to cloud or web portal or displaying on the device, data from the sensors used for another calculations.

In an exemplary implementation of dynamically managing the power based on internal power supply usage. A fuel gauge sensor can be utilized to detect the estimated battery left of PCD and can send an indication/signal to a microcontroller that can automatically disable selected sensors that are pre-determined to be turned off until battery is charged to certain threshold limit. When such event occurs, PCD can communicate to web server the amount of time the sensors are turned off and the subscription provider may opt to calculate a refund amount or credit back to the PCD owner.

In an exemplary implementation, when a user selects/switches a subscription, a subscription file can be downloaded from the server onto the PCD, and thereafter executed to implement activation of sensors/hardware elements at the firmware level and deactivation of other sensors/hardware elements. Such a subscription file can be in any file format that enables its execution at compatible/configured PCDs. In an aspect, the subscription file can be locally stored on the PCD. Details of the subscription to which the subscription file pertains can also be retrieved and stored (say in encrypted format) such that when a PCD storing the subscription details restarts or is reset, it can initially try to connect with the server and retrieve its corresponding subscription file for execution, but in case the server is not reachable or is taking time to respond, locally stored subscription settings can be used to activate/deactivate the sensors/hardware elements. In the meanwhile, the PCD can continuously/periodically/upon user request, try to get in touch with the server to fetch the latest subscription file.

In an aspect, user of a PCD can also change/select a subscription plan by connecting with the server through a web browser on any other computing device such as Laptop or a Personal Computer (PC) or PCD. In such a case, once the user is authenticated and selects/switches a subscription plan, subscription file/settings corresponding to the chosen subscription plan are directly sent to the corresponding PCD for execution/implementation of the settings.

In another aspect, it is still further possible for a user of a PCD to create his/her own subscription plan by selecting one or more hardware components/elements/sensors that he/she wishes to be activated, based on which an amount/fee (monthly or annual or one-time) can be estimated (say in real-time) and presented to the user for payment, upon performance of which the subscription plan details/settings can be sent to the respective PCD.

In an exemplary implementation, along with or apart from the UID, a subscription level request can be transmitted from the PCD to the server through any or a combination of short range communication mechanism or long range communication mechanism.

In another exemplary embodiment, in continuation of the above-mentioned scenarios, PCD can be configured to check, at the time of booting up, if the subscription level stored locally in it is the latest one or whether it has an update at a corresponding server. If an update exists at the server, the latest subscription plan or settings or file can be downloaded and executed rather than continuing to use the outdated one.

In an exemplary aspect, the present disclosure relates to a system configured in a user portable communication/computing device (PCD) for accessing at least one subscription level, wherein the proposed system can include a non-transitory storage device having embodied therein one or more routines operable to facilitate access to at least one subscription level, and one or more processors coupled to the non-transitory storage device operable to execute the one or more routines; wherein the one or more routines can include a unique identifier transmission module, which when executed by the one or more processors, transmits a unique identifier (UID) from the PCD to a subscription level server; a subscription level receive module, which when executed by the one or more processors, receives a subscription plan/level from the subscription level server to which the PCD is mapped (i.e. subscription to which the PCD pertains); and a subscription level processing module, which when executed by the one or more processors, processes/executes the subscription level at the user wearable portable communication device in order to activate one or more hardware elements/sensors/components that form part of the received subscription plan/level.

In an exemplary aspect, the proposed system can cater to various subscription offerings and helps in a) reducing shelf life of a product/device since a single type of device can serve multiple types of customers with various subscription needs and feature set requirements immediately, b) reducing wastage of goods/devices even if there is a demand fluctuation between specific types of customers who need only devices with certain limited features, c) reducing time in identifying the source components for each model of the device, d) power saving by selectively switching on and off the components based on the subscription or events and isolating the power and data flow to only specific used components, e) additional compliance by selectively monitoring the parameters that can be sensed and calculated by the in-built sensors, for which customer has agreed upon and provided a consent in monitoring rather than all the components that are available in the device collectively collecting data.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 illustrates exemplary components of a user wearable portable communication device or PCD.

FIG. 2 illustrates an exemplary architecture showing communication between one or more computing devices and a central server/cloud in accordance with embodiments of the present disclosure

FIG. 3 illustrates exemplary functional modules of a system configured to activate/deactivate one or more hardware components/elements/sensors of a computing device based on a subscription plan selected by a user of the computing device in accordance with embodiments of the present disclosure.

FIG. 4 illustrates an exemplary subscription registration form in accordance with embodiments of the present disclosure.

FIG. 5A illustrates an exemplary modification of subscription level in accordance with embodiments of the present disclosure.

FIG. 5B illustrates a exemplary data structure at server to store subscribed device details in accordance with embodiments of the present disclosure.

FIG. 6A illustrates an exemplary utilization of sensing/hardware activation mechanisms of a subscription level in accordance with embodiments of the present disclosure.

FIG. 6B illustrates exemplary subscription levels/plans in accordance with embodiments of the present disclosure.

FIG. 7 illustrates an exemplary representation showing detailed flow of subscription plan based sensor activation in accordance with embodiments of the present disclosure.

FIG. 8 illustrates an exemplary flow diagram depicting steps involved in accessing subscription levels in accordance with an embodiment of the present disclosure.

FIG. 9 illustrates an exemplary integrated circuit connections in which or with which embodiments of the present invention may be utilized in accordance with embodiments of the present disclosure.

FIG. 10 illustrates an exemplary computer system in which or with which embodiments of the present invention may be utilized in accordance with embodiments of the present disclosure

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

Embodiments of the present invention may be provided as a computer program product, which may include a machine-readable storage medium tangibly embodying thereon instructions, which may be used to program a computer (or other electronic devices) toper form a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The present disclosure relates to the field of a electronic/portable computing/communication device (such as a mobile phone/smart phone/smart watch). In particular, the present disclosure pertains to a system and method for enabling and disabling one or more hardware components/sensors/features of a portable computing device such as of a mobile phone or smart phone or smart watch based on a subscription chosen/selected by a user of the portable computing device.

In an aspect, the present disclosure relates to a portable computing device that comprises one or more hardware components/sensors/elements (collectively and interchangeably referred to hardware components or sensors hereinafter) such as but not limited to heart rate monitor, fall detector, blood pressure monitor, modem, magnetometer, gyroscope, accelerometer, GPS, temperature sensor, environment detector, sugar monitoring sensor, among any other like hardware/firmware level component that can be configured in the computing device. Although embodiments of the present disclosure have been explained with reference to smart watch, any other electronic device, portable and/or wearable computing device is well within the scope of the present invention. For example an electronic device inside an automobile or car serving the driver or passenger with specific needs based on the subscription chosen with the subscription service provider.

In an aspect, the present disclosure relates to a system architecture having a server/cloud comprising a memory that is configured to store a plurality of subscriptions (also interchangeably referred to as plans or levels or a combination thereof), each subscription comprising a list of features which includes data from at least one or more hardware elements/components/sensors that are to be activated in the proposed computing device as part of that respective subscription such that when user of a first computing device select a particular subscription/plan, hardware elements/components/sensors that form part of the selected subscription are activated in the first computing device. Once activated, the user can view outputs/parameters/deliverables of the activated hardware elements/components/sensors, and control/operate the same. Each subscription plan can be associated with a defined amount such that the user can choose an appropriate plan/subscription based on user preference, and even switch from one plan to another.

In an exemplary implementation, the present disclosures relates to sending, from an electronic device that can be either user wearable or portable computing device (PCD) or simply an electronic computing device (CD), a unique identifier (UID) associated with the PCD, to a subscription server (also referred to as subscription level server) that is operatively coupled with a plurality of PCD's over one or more networks; receiving, at the PCD, subscription plan to which the PCD is mapped; and configuring one or more sensors of the PCD based on received subscription plan. Such configuration can include activation and/or deactivation of one or more sensors based on details that form part of the subscription.

In an aspect, UID can be International Mobile Equipment Identity (IMEI) number or MEID (Mobile Equipment Identifier) of the PCD (in case the PCD is a mobile/smart phone, for instance) or can be any other unique identifier that can be associated with the PCD either by the manufacturer or by the proposed system. For instance, a PCD can initially register with the server/cloud storing the subscription plans, based on which registration, the server/cloud/system can automatically associate/assign a UID with the PCD based on the pre conditions stored in the software or hardware component in PCD and the conditions may include but not limited to key input parameters like customer location, address, age, type of subscription, length of subscription etc.

In an aspect, UID can be sent to server by using any or combination of short-range communication mechanism and long-range communication mechanism. Communication protocol being used can be wired or wireless, all of which possible scenarios are well within the scope of the present disclosure. UID can be encrypted or combined with other key value parameters during the transmission.

In an aspect, it is to be appreciated that the step of configuring/activating/deactivating the one or more sensors of the PCD based on received subscription plan can be implemented at firmware level and cannot be done manually through display interface of the proposed PCD. However, it may be possible for the user to, upon successful registration to the subscription from the PCD, control/configure, say through a settings options, the activated sensors/hardware elements, but the deactivated sensors/hardware elements cannot be viewed/activated unless there is a change to the subscription level through any such interface, which are activated only at the firmware level based on the subscription plan it received by the PCD from the server.

In an aspect, UID can be stored in a chip (communicatively coupled with a microprocessor/microcontroller), wherein chip can serve as a gateway/bridge/level shifter to various sensors, controlling signals such as power signals and data signals to the sensors. Upon PCD initialization, UID from the chip can be transmitted to server to get the subscription plan/level/status, and upon receiving the subscription response from server, chip can automatically enable/disable the data/power/current flow by a gating method to the respective sensors and can minimizes power consumption by disabling the sensors that were not opted.

In an exemplary aspect, sensors/hardware elements of the present invention can be selected from any or a combination of sensors for detecting fall, heart rate, pulse rate, body temperature, blood sugar, breath rate, Internet availability, location, 9-axis accelerometer measurements, magnetometer measurements, UV level, humidity level, proximity, CO₂ level, blood pressure, environmental conditions/parameters, among other parameters. Hardware components can further be configured for actions such as emergency calls, sending automatic alerts, and enabling Internet services. As explained above, each subscription plan can include one or more sensors/hardware elements that need to be activated under that plan.

In an exemplary aspect of dynamically managing the sensors based on events, selected sensors can be automatically get enabled/activated upon occurrence of certain events/conditions such as pressing of a SOS button, PCD reboot etc. Activated sensor(s) can stay active till the next reboot of the PCD or manual intervention or another occurrence of an event that can disable the one or more activated sensors. PCD can communicate with the server when such event (PCD reboot or manual intervention or disable sensor event) happens so that server can apply additional charges on top of the subscription charges for the duration the additional sensors are actively sensing sensory data and sending them to cloud or web portal or displaying on the device, data from the sensors used for another calculations.

In an exemplary implementation of dynamically managing the power based on internal power supply usage. A fuel gauge sensor can be utilized to detect the estimated battery left of PCD and can send an indication/signal to a microcontroller that can automatically disable selected sensors that are pre-determined to be turned off until battery is charged to certain threshold limit. When such event occurs, PCD can communicate to web server the amount of time the sensors are turned off and the subscription provider may opt to calculate a refund amount or credit back to the PCD owner.

In an exemplary implementation, when a user selects/switches a subscription, a subscription file can be downloaded from the server onto the PCD, and thereafter executed to implement activation of sensors/hardware elements at the firmware level and deactivation of other sensors/hardware elements. Such a subscription file can be in any file format that enables its execution at compatible/configured PCDs. In an aspect, the subscription file can be locally stored on the PCD. Details of the subscription to which the subscription file pertains can also be retrieved and stored (say in encrypted format) such that when a PCD storing the subscription details restarts or is reset, it can initially try to connect with the server and retrieve its corresponding subscription file for execution, but in case the server is not reachable or is taking time to respond, locally stored subscription settings can be used to activate/deactivate the sensors/hardware elements. In the meanwhile, the PCD can continuously/periodically/upon user request, try to get in touch with the server to fetch the latest subscription file.

In an aspect, user of a PCD can also change/select a subscription plan by connecting with the server through a web browser on any other computing device such as Laptop or a Personal Computer (PC) or PCD. In such a case, once the user is authenticated and selects/switches a subscription plan, subscription file/settings corresponding to the chosen subscription plan are directly sent to the corresponding PCD for execution/implementation of the settings.

In another aspect, it is still further possible for a user of a PCD to create his/her own subscription plan by selecting one or more hardware components/elements/sensors that he/she wishes to be activated, based on which an amount/fee (monthly or annual or one-time) can be estimated (say in real-time) and presented to the user for payment, upon performance of which the subscription plan details/settings can be sent to the respective PCD.

In an exemplary implementation, along with or apart from the UID, a subscription level request can be transmitted from the PCD to the server through any or a combination of short-range communication mechanism or long-range communication mechanism.

In another exemplary embodiment, in continuation of the above-mentioned scenarios, PCD can be configured to check, at the time of booting up, if the subscription level stored locally in it is the latest one or whether it has an update at a corresponding server. If an update exists at the server, the latest subscription plan or settings or file can be downloaded and executed rather than continuing to use the outdated one.

In an exemplary aspect, the present disclosure relates to a system configured in a user portable communication/computing device (PCD) for accessing at least one subscription level, wherein the proposed system can include a non-transitory storage device having embodied therein one or more routines operable to facilitate access to at least one subscription level, and one or more processors coupled to the non-transitory storage device operable to execute the one or more routines; wherein the one or more routines can include a unique identifier transmission module, which when executed by the one or more processors, transmits a unique identifier (UID) from the PCD to a subscription level server; a subscription level receive module, which when executed by the one or more processors, receives a subscription plan/level from the subscription level server to which the PCD is mapped (i.e. subscription to which the PCD pertains); and a subscription level processing module, which when executed by the one or more processors, processes/executes the subscription level at the user wearable portable communication device in order to activate one or more hardware elements/sensors/components that form part of the received subscription plan/level.

In an exemplary aspect, the proposed system can cater to various subscription offerings and helps in a) reducing shelf life of a product/device since a single type of device can serve multiple types of customers with various subscription needs and feature set requirements immediately, b) reducing wastage of goods/devices even if there is a demand fluctuation between specific types of customers who need only devices with certain limited features, c) reducing time in identifying the source components for each model of the device, d) power saving by selectively switching on and off the components based on the subscription or events and isolating the power and data flow to only specific used components, e) additional compliance by selectively monitoring the parameters that can be sensed and calculated by the in-built sensors, for which customer has agreed upon and provided a consent in monitoring rather than all the components that are available in the device collectively collecting data.

Various objects, features, aspects and advantages of the inventive subject matter will become more apparent from the following detailed description of preferred embodiments, along with the accompanying drawing figures in which like numerals represent like components.

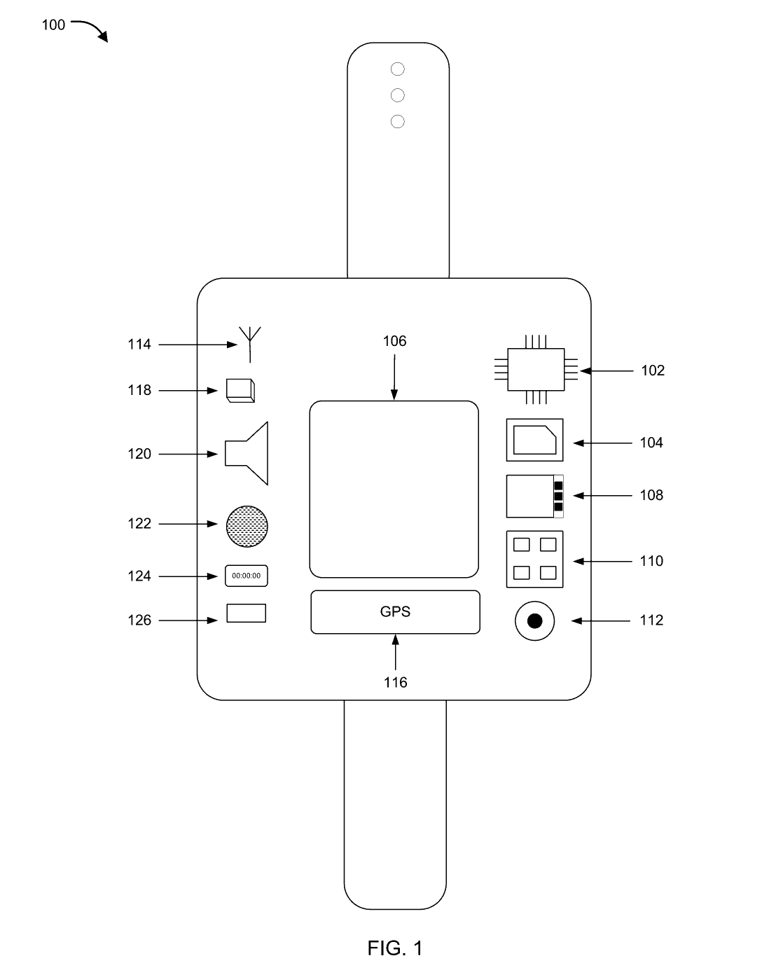

FIG. 1 illustrates a user wearable portable communication device/PCD (such as a smart watch 100) along with its various components that enable communication between the user wearable portable communication device and a web server/cloud. Computing device 100 includes a processor or micro controller (such as but not limited to Cortex-A Series (A5 and A7) that is coupled with one or more wireless communication module such as but not limited to CDMA/GSM/WCDMA/3G/4G/5G/LTE/Wi-Fi/BlueTooth/ZigBee/Radio Module 102 and/or graphics, audio and video processors, a memory controller 104 to provide an interface to off-chip memories, a display 106, a battery 108, network components 110, sensors 112, an antenna 114, a GPS 116, a codec 118, a speaker 120, a mic 122, a real time clock 124, and a level shifter 126. These components can be arranged in a central case or in the band that is attached to central case.

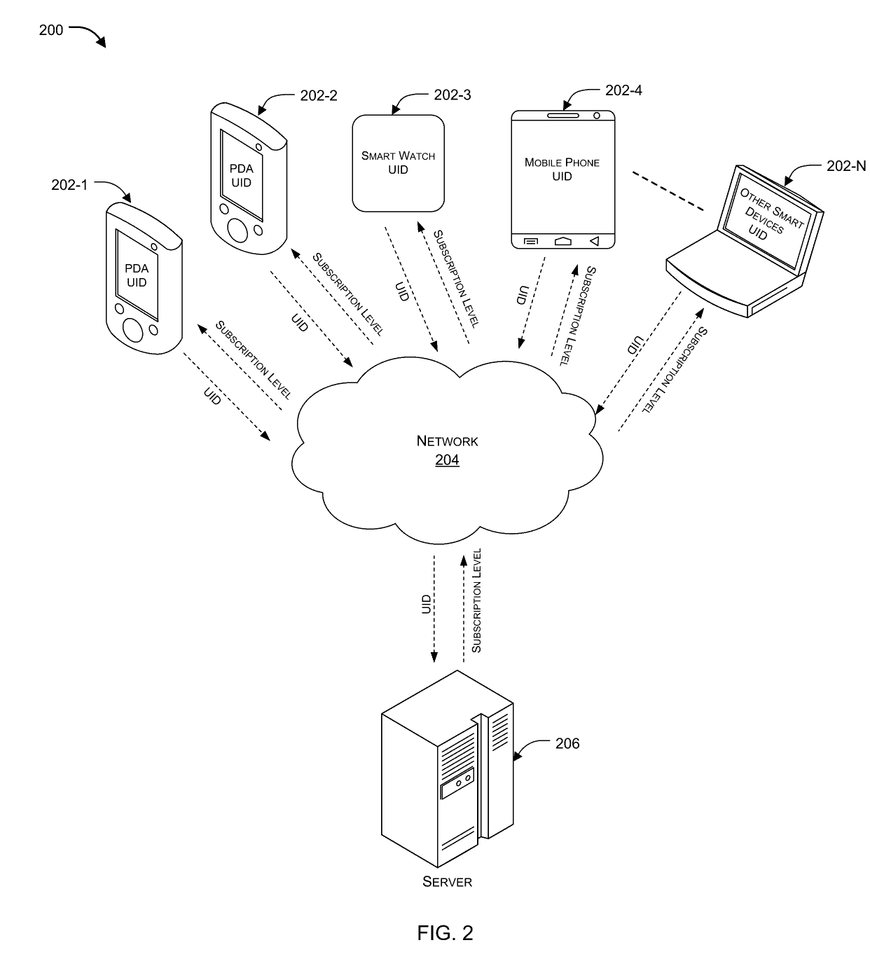

FIG. 2 illustrates an exemplary architecture showing communication between one or more computing devices and a central server/cloud in accordance with embodiments of the present disclosure. As shown, the proposed system architecture incorporates a plurality of computing devices 202-1, 202-2, . . . , and 202-N (collectively referred to as computing device(s) 202 hereinafter) (which may or may not be portable) such as a mobile phone, a smart phone, a smart watch, a fitness tracker, a laptop, a personal computer (PC), among other like computing devices, all of which are well within the scope of the present disclosure. In an aspect, such computing devices 202 can be operatively coupled with at least one server 206 (also referred to as cloud 206) through a network 204 (such as Internet or Local Area Network (LAN) or Wide Area Network (WAN)), wherein the server 206 can be a combination of different server components or can comprise a load balancer for balancing the requests from multiple computing devices 202. As would be understood, the proposed architecture is only an exemplary architecture and any other change in configuration such as incorporation of one or more network security devices such as firewalls, gateway devices, Intrusion Detection Systems (IDS), Intrusion Prevention Systems (IPS), among other like devices are well within the scope of the present disclosure.

In an exemplary implementation of the proposed system, as can be seen from FIG. 2, one or more computing devices (interchangeably, but in a non-limiting manner, referred to as portable computing devices (PCDs)), either at the time of booting up or booting down or during their normal course of operation, can send their respective unique identifier (UID) such as serial code or IMEI number or any other system-assigned unique identifier to the server 206 to enable the server 206 to, from its internal or operatively coupled database, retrieve the subscription level/plan that the respective computing device (or user of the respective computing device) has subscribed to. The server 206 can then send back a reply to each respective computing device with the subscription level to which it is mapped. Such a reply can, in an embodiment, include a subscription file pertaining to the subscription level, which subscription file, upon being received at the respective computing device, can be executed to enable and/or disable one or more hardware components/sensors that form part of the computing device based on the configuration defined in the subscription file.

In an aspect, more number of sensors can be activated for a more expensive subscription plan. In an aspect, in case a computing device does not have a hardware element/sensor that forms part of a subscription plan that the user of the computing device has selected, no action may be taken for that respective hardware element. In an aspect, each subscription plan can indicate the hardware elements/sensors that need to be activated as part of that plan, based on which when the subscription file of the plan is executed, the hardware elements/sensors that form part of the plan are activated and others, if activated, are deactivated.

In an aspect, upon detection of a low power or occurrence of an event that requires more power, PCD can auto disable or enable one or more sensors respectively. PCD can communicate enable/disable sensors information to the web server 206 through a HTTP/HTTPS/TCP/IP or any other communication protocol that is understood by both PCD and server 206. When server 206 receives enable/disable sensors information, server 206 can determine to add or deduct charges to the existing subscription based on the time/consumption of the additional resources or inability to get extra data.

In an aspect, the server can upgrade/downgrade the subscription plan based on occurrence of certain events including, but not limited to low power or pressing an emergency button.

It would be appreciated that portable communication device/computing device of the present disclosure is not limited to any device mentioned above, and any other device such as wristband, smart jewelry, tablet PC, PDA, an embedded controller, a computer-on-a-chip, a vehicle integrated computing device, a subscriber identification module (SIM) based electronic device, a smart television with one or more processors embedded therein and/or coupled thereto, or any combination or multiplicity thereof is well within the scope of the disclosure.

In an aspect, instead of sending the UID per se, it is also possible for a computing device 202 to send a request for subscription plan that pertains to the computing device to server 206, based on which the server 206, using a unique signature or packet identifier or through any other means identifies the requesting computing device and sends back the subscription plan mapped to the device.

In an aspect, user of a computing device can switch from one subscription plan to another. Such a switching action need not be initiated from the same computing device to which the subscription pertains, but can be done from any other computing device. For instance, in case a subscription plan pertains to a smart watch of user A; user A can also use his/her own laptop or desktop to connect with server 206, say through a browser or an application, and view/manage/edit/delete the subscription plans.

In an aspect, execution of the subscription file at a computing device is performed at firmware level to prevent user of the computing device to manipulate/control such execution and also to prevent user level activation/deactivation of one or more hardware elements/sensors. However, it may be possible that once a sensor such as accelerometer or barometer is activated at firmware level, user can control settings/preferences thereof.

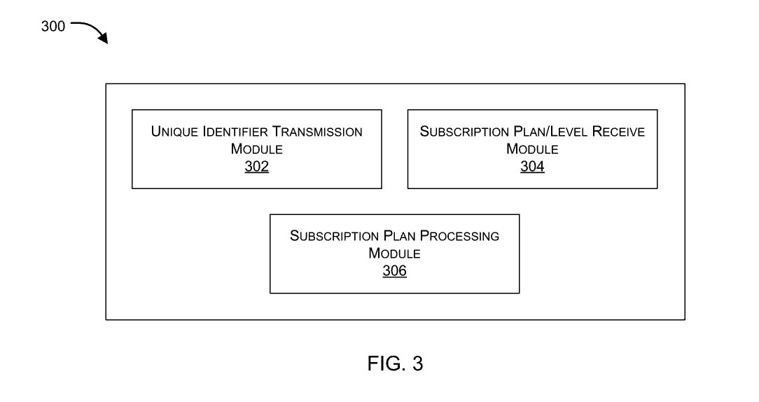

FIG. 3 illustrates exemplary functional modules of a system 300 called subscription subscriber identify module (SSIM) configured to activate/deactivate one or more hardware components/elements/sensors of a computing device based on a subscription plan selected by a user of the computing device in accordance with embodiments of the present disclosure. SSIM can be a hardware/Software/Logical/Functional module.

In an exemplary aspect, at least a part of the proposed system 300 can be configured in a computing device (also referred to as PCD), wherein such part of the system 300 can include a unique identifier transmission module 302 configured to, from the PCD, transmit a unique identifier (UID) of the PCD to a server that stores one or more subscription plans. In an aspect, system 300 can further include a subscription plan/level receive module 304 configured to receive, from the server, at the PCD, at least one subscription level that is mapped to the PCD, wherein the received subscription level can be in any format, say in the form of an executable subscription file that is indicative of what hardware elements/sensors are to be activated as part of the subscription level/plan. System 300 can further include a subscription plan processing module 306 configured to execute the received at least one subscription plan (say by executing the received subscription file or any other file format indicative of hardware elements/sensors to be activated/deactivated) to enable/disable activation of hardware elements/sensors that form part of the plan.

In an aspect, unique identifier transmission module 302 can be configured to send UID of a PCD to a server, wherein the UID can be transmitted to the server from the PCD at the time of device initialization/booting (or at any other time), wherein the booting can be executed by a boot loader. During the booting, CPU, long-range memory and/or other device network components can be activated to transmit the UID from the PCD to the server through a network. In an alternate embodiment, UID from a PCD can be transmitted to one or more servers after the PCD has fully initialized/turned on.

In yet another aspect, a PCD can send its respective UID to a server by using long range communication network including, but not limited to, a global system for mobile communications (GSM), local area network (LAN), wide area network (WAN), metropolitan area network (MAN), and a general packet radio service (GPRS), and the like.

In an aspect, subscription plan receive module 304 can be configured at the PCD to receive, from the server, a subscription plan or any file that can be used for activation of hardware components that form part of the plan.

In an exemplary embodiment, data transmission from PCD to server or vice versa can be done in any of simplex mode, half duplex mode, and or full duplex mode.

In an aspect, data transmission through a network from PCD to a server and vice versa can be executed by utilizing one or more network security mechanisms such as encryption/decryption, cipher text, RSA, SHA-1, and the like.

In an aspect, subscription plan processing module 306 can be configured at PCD to process/execute received subscription file or information received from the server so as to activate/deactivate one or more hardware elements/sensors/components that form the part of the received subscription level/plan.

In another aspect, after receiving subscription file (also interchangeably referred to as subscription level firmware) at a PCD, the received subscription file can be stored/downloaded in memory of or operatively coupled to PCD. Such a subscription file can also be executed every time the PCD is restarted. Furthermore, stored subscription file can be used for execution whenever the PCD is not able to get in contact with the server. In another aspect, PCD can be configured to, at defined intervals or at user-initiated intervals, execute modules 302-306 so that in case user of the PCD changes/updates/modifies his/her subscription plan, the latest subscription level firmware can be downloaded onto the PCD and executed to activate the sensors that form part of the latest subscription plan. As mentioned above, such execution can take place at the firmware level itself.

In an aspect, it may be possible that different servers are configured in the proposed system, wherein each server can be used for a different type subscription. For instance, server A can be configured to manage subscription plans for health related hardware components/sensors, whereas server B can be configured to manage subscription plans for environment related hardware elements/sensors. Therefore, it may be possible for user of a PCD to subscribe to multiple subscription plans and send multiple requests (having UID of the PCD) to respective servers for retrieval and execution of respective subscription plans. All further extensions of the core invention step are therefore well within the scope of the present disclosure.

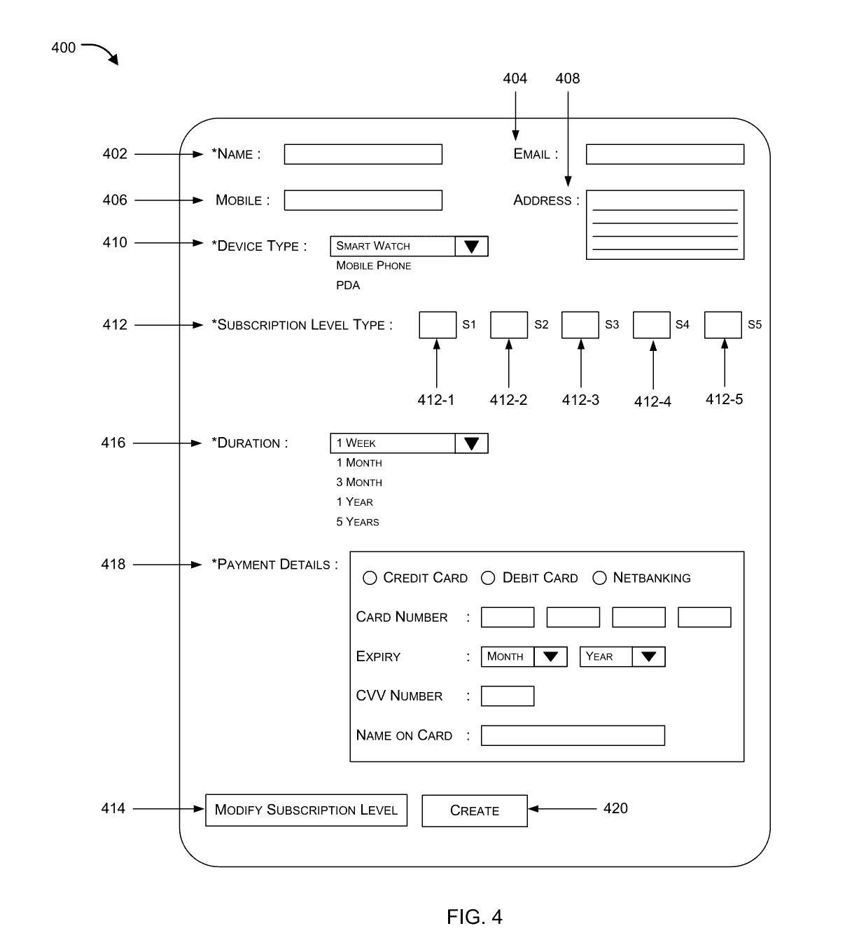

FIG. 4 illustrates an exemplary subscription registration form in accordance with embodiments of the present disclosure. As shown in FIG. 4, initial subscription registration form 400 can include one or more entries to be submitted by a user of PCD to become a subscriber of subscription plan/level such as S1 412-1, S2 412-2, S3 412-3, S4 412-4 and S5 412-5. In an aspect, among all the entries, few entries annotated with asterisk may be made mandatory for submission by the user such as, Name 402, Device type 410, Subscription Level Type 412, Duration 416, Payment details 418, and Create Button 420. Other entries such as Email id 404, Mobile number 406, Address 408 and Modify Subscription Level 414 can be optionally filled by the user.

In an aspect, subscriber registration form can provide an option to the user to select an appropriate layout/theme from an array of layouts, an option to enter/select other customization inputs such as look and feel of the application, background theme, font and size of displayed text, radio buttons, subscription levels textbox(es), text fields (such as 402, 404, 406), drop down menus (such as 410, 416), adjustment of resolution of one or more graphical user interface (GUI) elements, buttons, text color, and any other desired displayed element.

In an aspect, subscription form can be submitted by a user by entering desired subscription form fields on a display interface of PCD. In an alternate aspect, the user can submit the subscription form by submitting entries in any computing device connected to a long range network. The form may also be submitted physically or through email or any other configured means.

In an aspect, user of PCD can provide an input to different subscription plans/levels (such as S1 412-1, S2 412-2, S3 412-3, S4 412-4 and S5 412-5) in order to obtain details of each subscription level. For instance, user can provide input by clicking a mouse cursor, by hovering on a particular subscription level, voice command, gesture command, and the like and automatically details of that subscription level can be presented on display of the PCD. In an alternate embodiment, subscription levels can be hyperlinked, which, upon receiving an input, automatically fetch their respective details from a long-range network.

In an aspect, after filling all mandatory entries in the subscription form, user can provide an input to Create button 420, which, upon receiving such input, transmits the filled subscription form information/data to a subscription level server through a long-range network such as Internet.

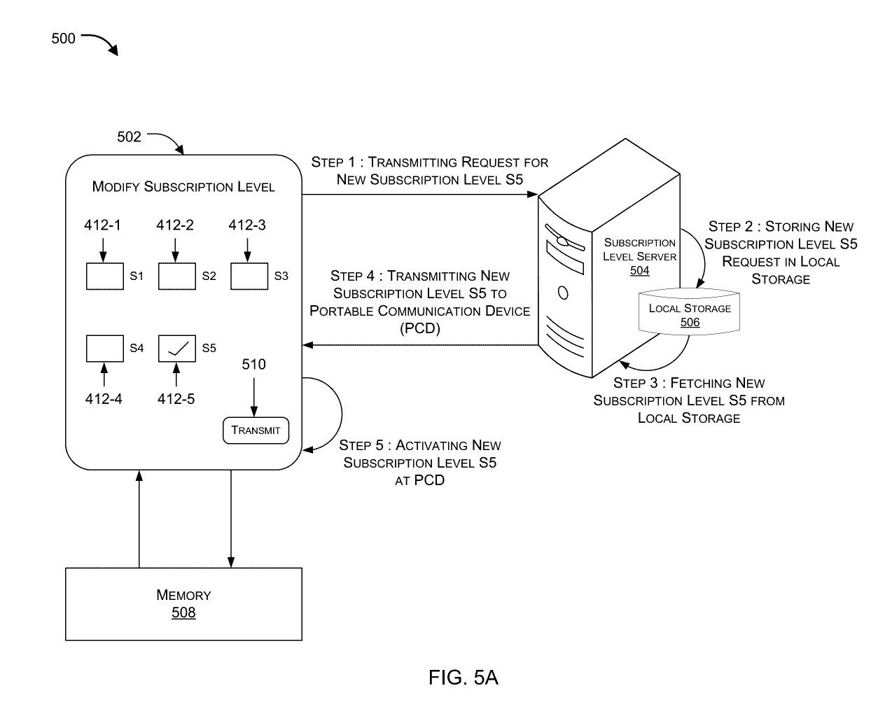

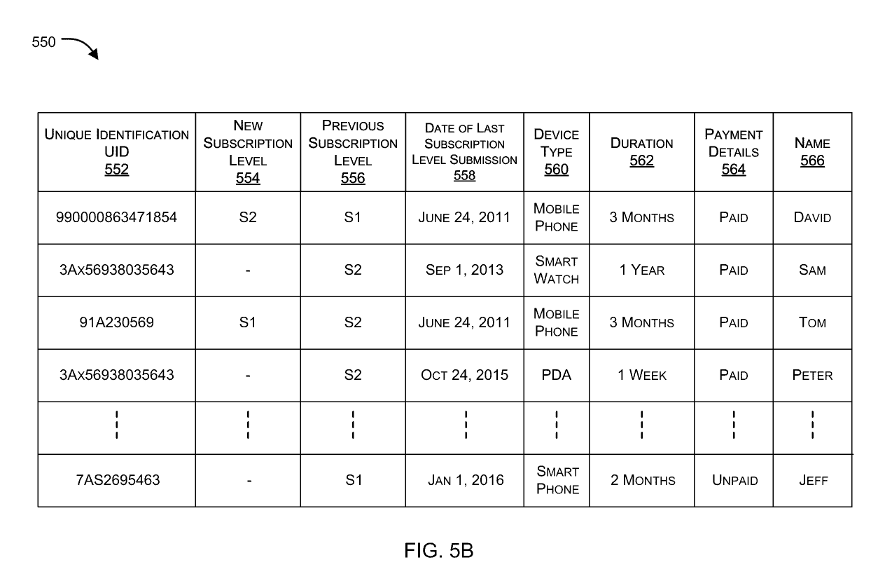

FIG. 5A illustrates an exemplary modification of subscription level in accordance with embodiments of the present disclosure. As shown in FIG. 5A, upon receiving an input by a user on Modify Subscription Level 414 (of subscription form 400 of FIG. 4), interface of subscription level form can change to a new subscription form interface such as shown in 502, which can include different subscription levels S1 412-1, S2 412-2, S3 412-3, S4 412-4 and S5 412-5. As depicted in 502, user can choose a desired subscription level. For instance, 502 shows that user selected subscription level can be changed from S1 412-1 to say S5 412-5, and upon receiving a click on the transmit or submit button 510, at step 1, selected subscription level S5 412-5 information can be transmitted to a subscription level server 504/cloud. At step 2, the subscription level server 504 can store the new received subscription level request in a data structure (such as one shown in FIG. 5B) available at a local storage 506 (for instance), and at step 3, the server 504 can fetch/retrieve the requested new subscription level S5 412-5 from the local storage 506. In an aspect, the storage 506 can be within the server 504 and/or on another storage device to which the server 504 is coupled. Furthermore, at step 4, the server 504 can transmit the new updated subscription level S5 to a PCD, wherein the PCD, upon receiving the new updated subscription level, at step 5, can process/execute the firmware of the new subscription level (S5) to activate one or more hardware elements/sensors/components that form the part of the received subscription level/plan. In an aspect, newly received subscription level can be stored in a memory 508 associated with the PCD. In an aspect, the memory 508 can be PCD in-built memory and/or an external memory of another computing device such as server storage, laptop storage, and personal computer storage. In another aspect, coupled memory can be a memory bank, Serial ATA, and the like.

In an aspect, polling can be performed by the PCD to check for any update of subscription plan on the server 504, say on an hourly or daily or fortnightly basis or at any other desired interval. In an alternate aspect, polling can be performed in real time. In another aspect, server 504 can be configured to intimate and/or update a PCD as soon as its subscription plan/level is modified. Such intimation can be, for instance, in the form of downloading the updated subscription file onto the PCD, which subscription file/information can be executed at firmware level to activate/deactivate hardware components based on the modified subscription plan/level.

In an aspect, polling can be performed any time after the PCD is turned on or while the boot loader is initializing the device. In another aspect, upon PCD initialization, its UID can be transmitted to subscription level server 504, wherein upon receiving the transmitted UID, the server 504 can check for updation of subscription level.

In an aspect, after determining, by the subscription level server 504, that no updation has occurred, server may not send any message/file/information to the PCD and PCD booting can be continued. In an alternate aspect, if the subscription level server 504 determines that subscription level has been updated/altered, the server 504 can send appropriate subscription level firmware to the PCD, which the PCD can receive/download, post which the proposed system can automatically re-initialize the PCD and activate PCD hardware components/sensors that form the part of received subscription level firmware. In an aspect, updated/customized/modified subscription level firmware can be transmitted to the PCD in real time.

In an aspect, subscription levels S1 412-1, S2 412-2, S3 412-3, S4 412-4 and S5 412-5 are only exemplary in nature, and in actual implementation, any number of subscription plans/levels or sub-plans can be provided to enable the aspects of the disclosure. User can also be allowed to customize his/her plans or set any other preferences/settings. For instance, a user may configure that a fall detection sensor be activated from 6 AM to 12 PM, and then deactivated from 12 AM to 6 PM.

In an aspect, upon receiving a user request for subscription level, subscription level server 504 can be connected to one or more third party servers to perform verification of user entries, for instance, upon receiving payment details at server 504, the server 504 can connect to a third party server such as a bank/payment server to verify various payment details such as card number, card type (debit/credit), CVV number, and the like.

FIG. 5B illustrates an exemplary data structure at subscription level server in accordance with embodiments of the present disclosure. FIG. 5B shows a data structure 550 that can be utilized to maintain subscription plan/levels details against each subscribed PCD UID. For instance, a logical table can be maintained at the server to maintain details of one or more subscribed devices. As illustrated, the table can include entries such as Unique Identifier (UID) 552, New Subscription Level 554, Previous Subscription Level 556, Date of Last Subscription Level Submission 558, Device Type 560, Duration 562, Payment Details 564, and Name of User 566. For example, 990000863471854 can be the UID of a PCD, New Subscription Level can be S2, Previous Subscription Level as S1, Date of Last Subscription Level Submission as Jun. 24, 2011, Device Type can be Mobile Phone, Subscription Duration can be 3 months, Payment Details can be Paid, and Name of the User as David. As one would appreciate, such a table is only exemplary in nature and any other format, content, attribute, can included to enable aspects of the present disclosure.

In an exemplary aspect, table entries such as Unique Identifier (UID) 552, New Subscription Level 554, Previous Subscription Level 556, Date of Last Subscription Level Submission 556, Device Type 558, Subscription Duration 562, Payment Details 564 and Name of User 566 are only exemplary in nature, and any number of additional/reduced entries can be provided to enable the aspects of the disclosure.

In an aspect, a user can switch to a new subscription level any number of times, wherein each time, upon receiving a new subscription level, entries of the table 550 can be refreshed/updated.

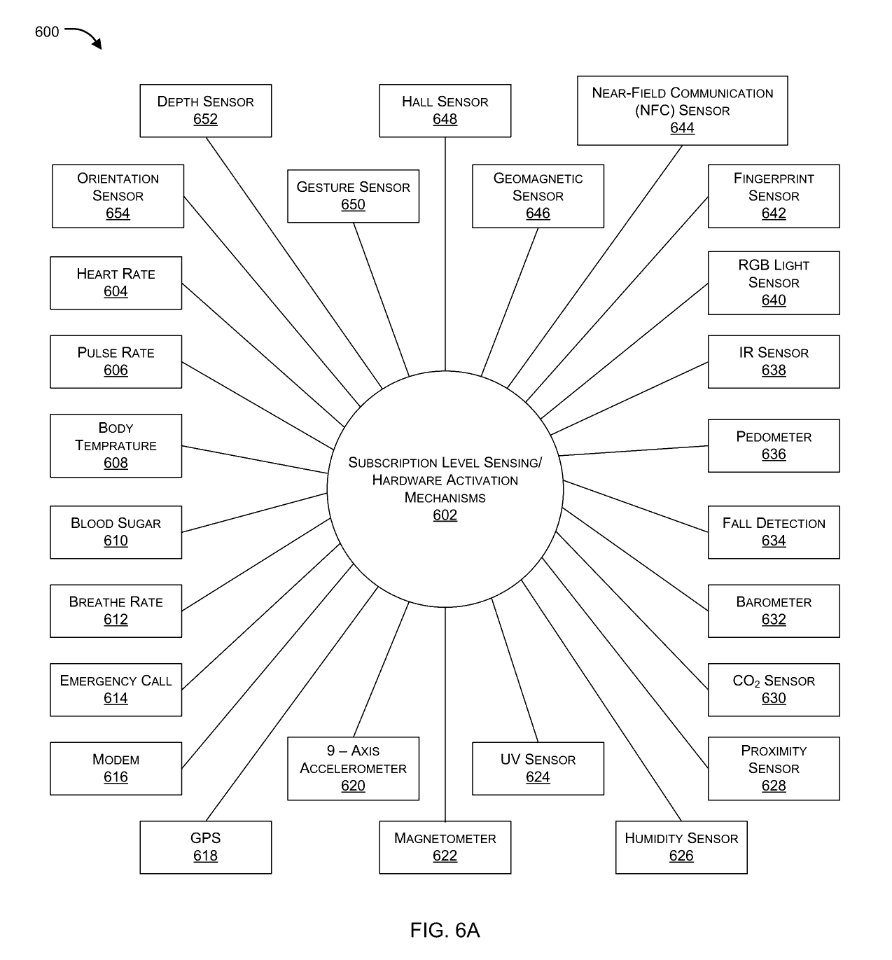

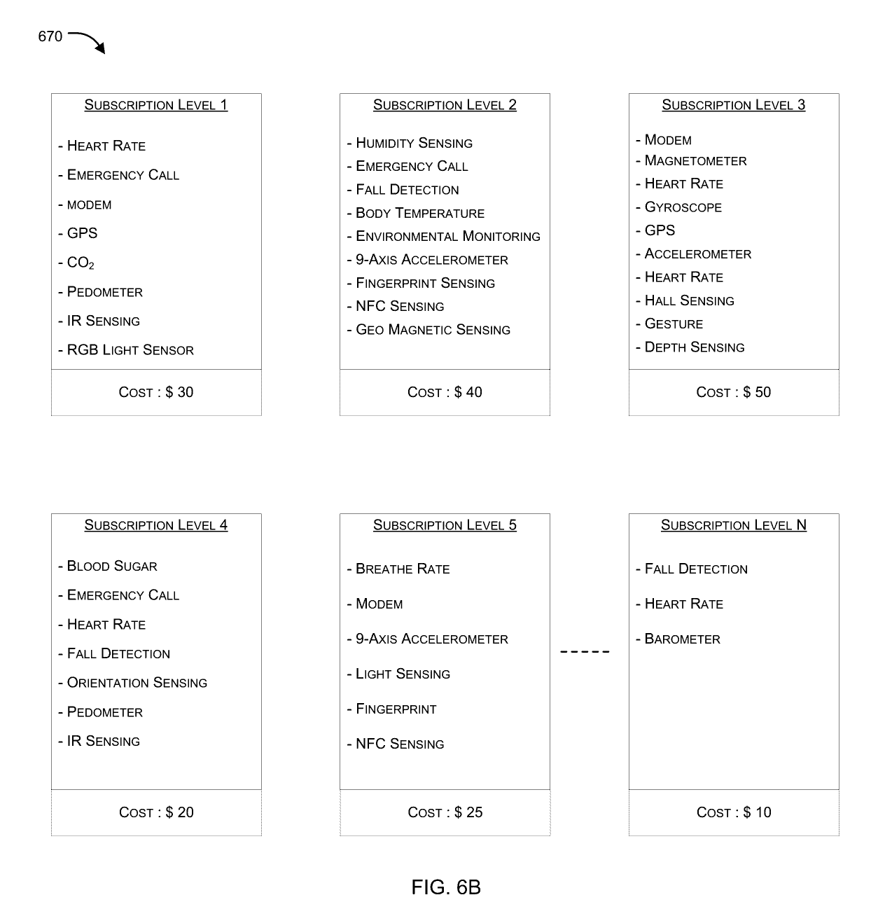

FIG. 6A illustrates an exemplary utilization of sensing/hardware activation mechanisms of a subscription level in accordance with embodiments of the present disclosure. As illustrated, subscription level server 602 can enable selection of a plurality of sensors and/or hardware components such as a heart rate sensor 604, a pulse rate sensor 606, a body temperature sensor 608, a blood sugar sensor 610, a breath rate sensor 612, an emergency Call element 614, a modem 616, a GPS 618, a 9-axis accelerometer 620, a magnetometer 622, a UV sensor 624, a humidity sensor 626, a proximity sensor 628, a CO2 sensor 630, a barometer 632, a fall detection sensor 634, a pedometer 636, an IR sensor 638, a RGB light sensor 640, a fingerprint sensor 642, a Near-Field communication (NFC) sensor 644, a geomagnetic sensor 646, a hall sensor 648, a gesture sensor 650, a depth sensor 652, an orientation sensor 654, among any other suitable sensor and/or hardware component, each subscription plan configured by the server can include one or more sensors/elements that would be activated as part of the respective plan. A user can accordingly select a suitable plan based on its sensor/component coverage and plan amount, and download the subscription file to enable activation of the desired sensors/components in the respective PCD.

In an aspect, upon subscribing for a particular subscription level, one or more sensing mechanisms can be activated at the configured PCD. For instance, a user can subscribe for a Subscription level 2, wherein Subscription level 2 automatically activates fall detection sensor 634 on PCD and enables the PCD to detect when PCD falls suddenly and issue necessary notifications alerting about the fall to one or more pre-configured numbers (including remote monitoring stations) indicating that the PCD user needs assistance as PCD suddenly fell down.

In an aspect, measured physiological parameter alerts such as heart rate, pulse rate, SPO₂, body temperature can be transmitted to one or more pre-configured numbers, wherein alerts/notifications can be in any form, including but not limited to, textual form, blink, audio and/or video file. In another aspect, textual alert can be transmitted as SMS and/or chat messenger message. In an aspect, upon receiving the voice message, voice signals can be generated to attract attention of user of pre-configured number. In an aspect, upon receiving the alert, any application stored on a device related to pre-configured number can start execution such as turning on any audio file and/or turning on torch.

In an aspect, alerts can be color-coded, for example, yellow alert can indicate abnormal situation and red color alert can indicate a dangerous situation and immediate assistance.

In an aspect, alerts/notifications can include measured physiological parameter and/or other information such as timestamp or recorded parameter/video recording of a PCD user.

As one may appreciate, sensors mentioned above are only exemplary in nature and can include more suitable hardware activation mechanisms that can enable aspects of the invention and all such hardware activation mechanisms are well in the scope of the disclosure.

In an aspect, PCD can receive an acknowledgement alert from the preconfigured number user after the former has delivered PCD notification to the latter.

In an aspect, it is to be appreciated that the step of configuring/activating/deactivating one or more sensors of PCD based on received subscription plan can be implemented at firmware level, and may not be configurable manually through a display interface of the proposed PCD. However, it may be possible for the user to control/configure, say through a settings options, the activated sensors/hardware elements, but the deactivated sensors/hardware elements cannot be viewed/activated through any such interface and are activated only at the firmware level based on the subscription plan received by the PCD from the server.

FIG. 6B illustrates exemplary subscription levels/plans in accordance with embodiments of the present disclosure. In an aspect, different sensing/hardware activation mechanisms can be packaged into different subscription plans such as Subscription Level 1, Subscription Level 2, Subscription Level 3, Subscription Level 4, Subscription Level 5, and Subscription Level N, wherein each subscription level can include one or more sensing mechanisms such as Subscription Level 1 can include sensing mechanism pertaining to heart rate, emergency call, modem, GPS, CO2, pedometer, IR sensor, RGB light sensor, Subscription Level 2 can include sensing mechanisms pertaining to humidity sensing, emergency call, fall detection, body temperature, environmental monitoring, 9-axis accelerometer, fingerprint sensor, NFC sensor, geomagnetic sensor, Subscription Level 3 can include sensing mechanisms pertaining to modem, magnetometer, heart rate, gyroscope, GPS, accelerometer, heart rate, hall sensor, gesture, depth sensing, Subscription Level 4 can include sensing mechanisms pertaining to blood sugar, emergency call, heart rate, fall detection, orientation sensor, pedometer, IR sensor, and Subscription Level 5 can include sensing mechanisms pertaining to breathe rate, modem, 9-axis accelerometer, light sensor, fingerprint sensor, NFC sensor, and so on. It may also be possible for a user to select more than one subscription plan at the same time.

In an aspect, PCD of the present disclosure can be configured to send data that has been received from one or more data collection devices to one or more remote monitoring stations through a long range communication network, wherein the data received at the remote monitoring station can be securely stored in a secure data bank that is associated with the remote monitoring station. In an exemplary aspect, long range communication network can include, but is not limited to, a global system for mobile communications (GSM), local area network (LAN), wide area network (WAN), metropolitan area network (MAN), and a general packet radio service (GPRS), and the like.

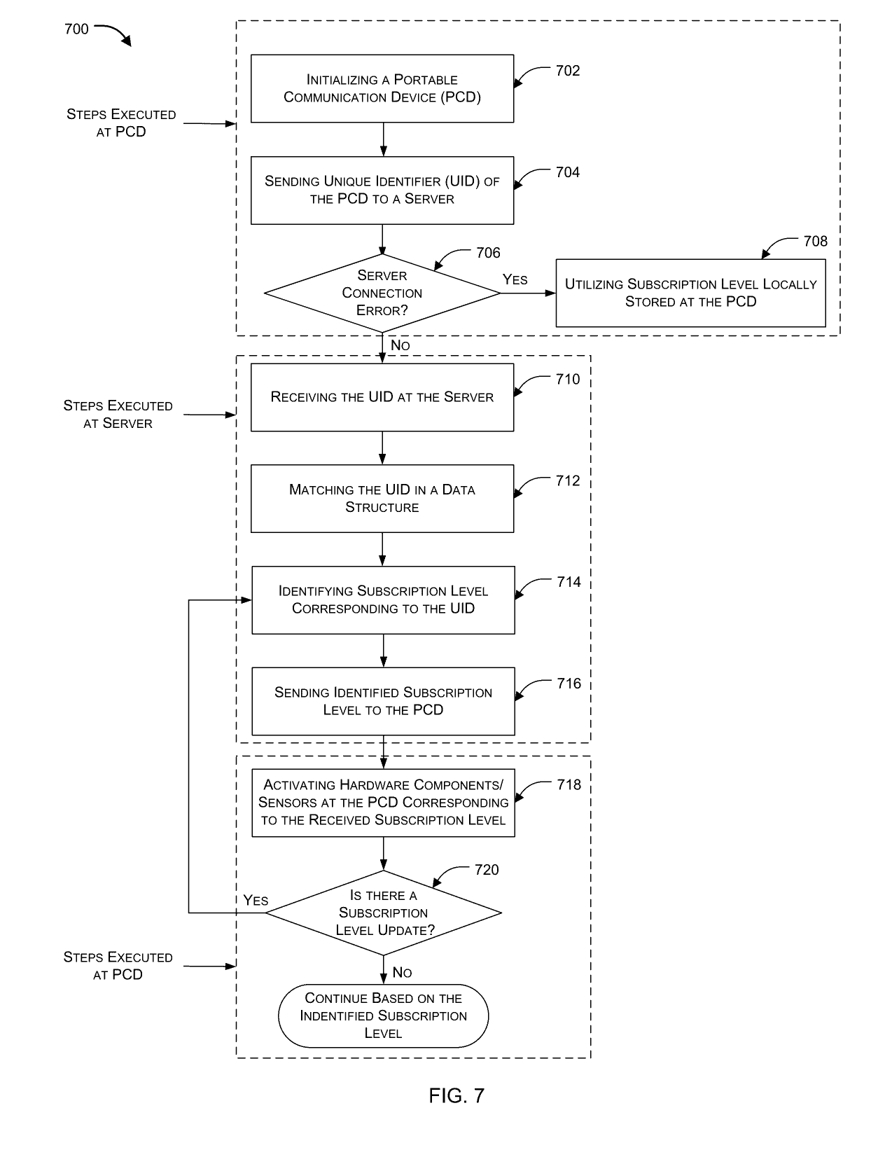

FIG. 7 illustrates an exemplary representation showing detailed flow of subscription level based hardware activation in accordance with embodiments of the present disclosure. In an aspect, the proposed method can include the steps of, at step (702), turning on a PCD, at step (704), transmitting a unique identifier (UID) of the PCD to a server, at step (706) checking whether connection with the server exists such that if the connection is not established, at step (708), locally stored subscription plan/level is utilized to activate/deactivate hardware sensors/components, whereas if the connection is established, at step (710), UID of the PCD is transmitted (manually or automatically) to the server. The method can further include the step of, at step (712), at the server, matching the received UID in a data structure where details of subscriptions are stored, at step (714), identifying an appropriate subscription level corresponding to the UID, and at step (716), sending subscription level firmware of the identified subscription level to the PCD. Furthermore, at step (718), the method involves execution of the subscription level firmware at the PCD to enable activation/deactivation of one or more sensors/hardware components based on the subscription level firmware, and at step (720), checking if a change in subscription level has taken place such that if the change has occurred the method goes back to step 714, else the PCD continues to function normally with the activated set of hardware components.

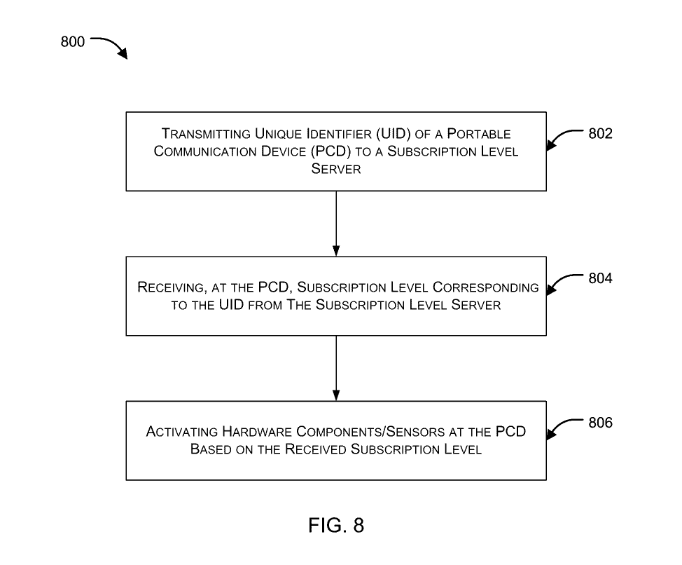

FIG. 8 illustrates an exemplary flow diagram depicting steps involved in accessing subscription level in accordance with an embodiment of the present disclosure. In an aspect, the proposed method can include the steps of, at step (802), transmitting unique identifier (UID) of a portable communication device (PCD) to a subscription level server, and at step (804), receiving, at the PCD, subscription level corresponding to the UID from the subscription level server. The method can further include the step of, at step (806), activating hardware components/sensors at the PCD based on the at received subscription level.

In an aspect, any or a combination of machine learning mechanisms such as decision tree learning, Bayesian network, deep learning, random forest, supervised vector machines, reinforcement learning, prediction models, and the like can be employed to learn sensor/hardware components typically used/activated by different users, and accordingly predict and define new subscription level packages at the server that can be utilized by other users. Such models can also be used to recommend a subscription plan to defined user based on his/her demographic, psychographic attributes, among other behavioral/usage patterns.

In an aspect, the present disclosure relates to a portable communication device (PCD) for accessing and processing at least one subscription level comprising: a non-transitory storage device having embodied therein one or more routines operable to facilitate accessing and processing at least one subscription level; and one or more processors coupled to the non-transitory storage device and operable to execute the one or more routines that include: a subscription plan receive module, which when executed by the one or more processors, receives, at the PCD, from a server, a subscription plan corresponding to the PCD; and a subscription plan processing module, which when executed by the one or more processors, activates/deactivates the status of one or more hardware components and/or sensors at the PCD based on the received subscription plan.

In an aspect, the one or more routines can further include a unique identifier transmission module, which when executed by the one or more processors, transmits a unique identifier (UID) of the PCD to the server, in response to which the server returns back the subscription plan to the PCD.

In an aspect, the UID is International Mobile Equipment Identity (IMEI) number or MEID (Mobile Equipment Identifier) of the PCD.

In another aspect, the received subscription plan is an executable file that is executed by the PCD to activate the one or more hardware components and/or sensors at the PCD.

In an aspect, the server stores a plurality of subscription plans, each plan having a defined number of hardware components and/or sensors that are to be activated as part of the respective plan such that when a user selects the subscription plan, the one or more hardware components and/or sensors that form part of the selected subscription plan are activated at firmware level.

In an aspect, the firmware level activation of the one or more hardware components and/or sensors disallows manual activation/deactivation of the one or more hardware components and/or sensors through interface of the PCD.

In an aspect, the firmware level activation of the one or more hardware components and/or sensors deactives other hardware components and/or sensors that do not form part of the subscription plan.

In an aspect, the subscription plan is selectable through the PCD or another computing device selected from any of a laptop, a PC, a mobile phone, a smart phone, a smart watch, a PDA, and a touch interface-based computing device.

In an aspect, the PCD is any or a combination of a mobile phone, a smart phone, a tablet PC, a PDA, a smart watch, a wearable computing device, and a touch interface-based computing device.

In an aspect, the one or more hardware components and/or sensors are selected from any or a combination of a fall detection sector, a heart rate detector, a pulse rate detector, a body temperature sensor, a blood sugar detection sensor, a breath rate sensor, emergency call detector, a modem, a GPS, a 9-axis accelerometer, a magnetometer, a health-attribute measurement sensor, a PCD feature enabling hardware component, a UV sensor, a humidity sensor, a proximity sensor, a CO2 sensor, and a barometer.

In an aspect, the subscription plan is switched to a second subscription plan by user of the PCD such that the second subscription plan is received by the PCD in real-time or after an update request is sent by the PCD at periodic/defined intervals, and wherein based on the received second subscription plan, corresponding hardware components and/or sensors are activated and others are deactivated.

In an aspect, the subscription plan is stored locally on the PCD such that if, upon restart or during operation, the PCD is not able to reach the server, the locally stored subscription plan is used for activation/deactivation of the one or more hardware components and/or sensors.

In an aspect, upon activation of the one or more hardware components and/or sensors, user of the PCD is enabled to configure one or more parameters of the activated hardware components and/or sensors through interface of the PCD.

In an aspect, the PCD is configured such that hardware components and/or sensors that are not activated as part of the subscription plan cannot be activated through interface of the PCD.

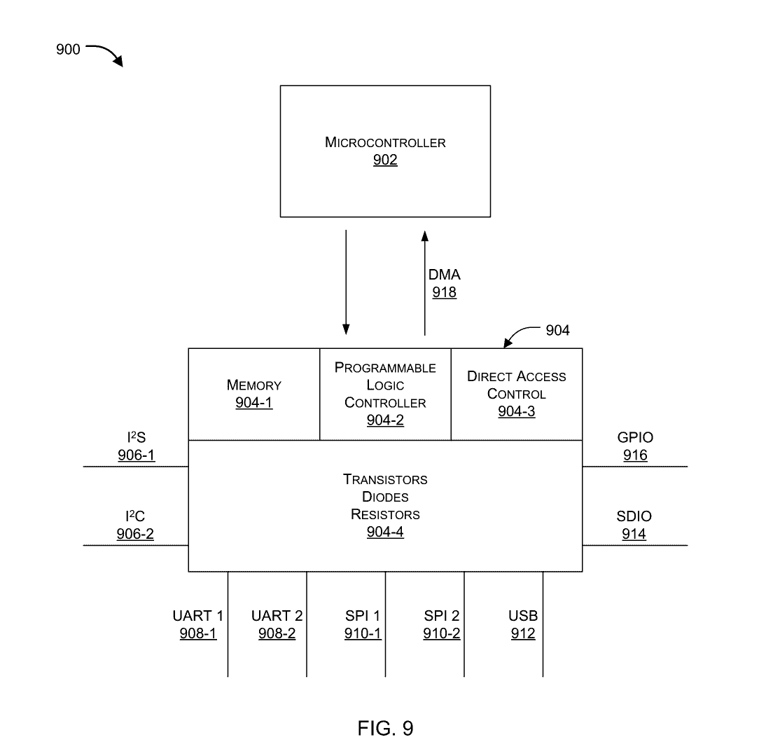

FIG. 9 illustrates another principle object of the invention, a subscription enabler integrated circuit, Since the illustrated embodiments of the present invention may for the most part, be implemented using electronic components and circuits known to those skilled in the art, details will not be explained in any greater extent than what is necessary.

FIG. 9 illustrates a microcontroller 902, operatively coupled with an integrated circuit (IC) 904 that can include a memory 904-1, a programmable logic controller 904-2, a direct access control 904-3 and a set of electronic components 904-4 that can include a plurality of transistors, diodes, resistors and clock. Either power gating or clock gating will control various type of input/outputs based on the subscription, Even though only one or two inputs are considered in the drawings, it is obvious that the IC 904 can control one or more forms of input/outputs like UART, USART, SPI, I2C, I2S and SDIO.

IC 904 can utilize Integrated Inter-IC Sound Bus (I²S) 906-1 as a serial bus interface for communication, I²C 906-2 as a serial computer bus, two universal asynchronous receiver/transmitter (UARTs) 908-1 and 908-2 for asynchronous serial communication to enable data format and transmission speeds as configurable, two serial ports 910-1 and 910-2 and a USB port 912. Furthermore, a Secure Digital Input Output (SDIO) card interface 914 can be configured to enable use of a standard SD card slot and a General-purpose input/output (GPIO) pin 916 can be configured to be controllable as input pin or output pin at runtime. Direct memory access (DMA) 918 can also be utilized for communication between microcontroller 902 and IC 904.

Upon power on of IC 904, software program running inside the micro controller can set the registers, GPIO's based on the subscription level received from the subscription server. Once the registers were set the IC will automatically enable/disable the power and data to the Input/outputs.

In an exemplary embodiment, the IC 904 itself can contact the microcontroller or subscription server and get the subscription level/plan and depending on that subscription it will control the power and data to the respective input/outputs.

In an exemplary embodiment, the IC 904 can have an EPROM which will have the subscription level stored and when the IC 904 is powered on, based on the subscription level it will automatically enable/disable the power and data to input/outputs. When there is a change in the subscription level the value in EPROM will be modified to reflect the latest subscription status.

In an aspect, the present disclosure relates to a system comprising a portable communicative device (PCD) configured to dynamically control access to its one or more hardware components based on subscription status, said system comprising a form factor for the PCD; at least one processor loaded with instructions that manipulates registers during processing; a non-transitory storage device having embodied therein one or more routines operable to facilitate accessing to at least one specific hardware servicing component; and one or more processors coupled to the non-transitory storage device and operable to execute the one or more routines; at least one step to enroll into a subscription plan containing set of features; at least one feature that is dependent on the access to a specific hardware servicing component and a price associated with each subscription plan based on the usage; PCD communicatively coupled with the subscription server and includes at least one step to identify the status of the subscription based on a unique identifier of the PCD; and means to dynamically control flow by at least one gating method to a specific hardware servicing component depending on the subscription status and features resulting in a change to at least one metric value.

In an aspect, the form factor of the PCD can be any or a combination of: a smart watch; a mobile phone; a computer; a fitness tracker; and an electronic device.

In an aspect, the processor can be selected from any or a combination of a hardware processor, and a software processor.

In an aspect, the instructions can be selected from any or a combination of high level language instructions; Low level language instructions; binary instructions; machine understandable instructions; assembly instructions; and interactive instructions.

In another aspect, the non-transitory storage is selected from any or a combination of a programmable read only memory (PROM); an erasable programmable read only memory (EPROM); an electrically erasable programmable read only memory (EEPROM); and an addressable space.

In an aspect, the step of registering/enrolling into a subscription plan is selected from any or a combination of: an application accessible from an electronic device, a written note, a verbal note, and an interactive instructions.

In another aspect, the at least one hardware servicing component includes any or a combination of fall detection, a heart rate, a pulse rate, a body temperature, a blood sugar, a breath rate, emergency call, modem, GPS, 9-axis accelerometer, magnetometer, UV sensor, temperature sensor, fuel gauge sensor, shock sensor, humidity sensor, proximity sensor, CO₂ sensor and barometer.

In yet another aspect, the price for each subscription plan is any of a fixed price irrespective of usage for a period of time or an adjusted price based on the usage for a period of time.

In another aspect, the subscription server can be any or a combination of a web server; an application loaded inside the PCD; an addressable memory space inside an integrated circuit; or a pair of switches to toggle.

In another aspect, the PCD can be communicatively coupled with the subscription server by at least one of a short range communication; a long range communication; a wired communication; a wireless communication; or data communication, wherein the short range communication can be selected from any or a combination of a Bluetooth communication, a zigbee communication, a near field communication, or a radio signal communication. In an aspect, the long range communication can be selected from any or a combination of a cellular communication, a Wi-Fi communication, a Satellite communication, and a radio signal communication.

In an aspect, the unique identifier can be at least one of a IMEI (International Mobile Equipment Identify Number); a MEID (Mobile Equipment Identifier); an unique number stored in the memory of an integrated circuit; a hardcoded number in the application program; an unique number that is assigned at the time of the registration.

In an aspect, the unique identifier can represent at least one of the duration of the subscription plan; the age of subscriber; the location of the subscriber; the type of the PCD; or the model of the PCD.

In an aspect, the step of identifying the status of the subscription is at least one of a web service call to a subscription server; a read from an addressable memory space; a data exchange with storage; or a method of reading the status of the controllable switches.

In an aspect, means to control the flow is through at least one of a software application loaded in the processor; a hardware circuit; or a subscription enabler integrated circuit. In an aspect, the integrated circuit is communicatively coupled to at least one hardware servicing component through at least one communicative method. In an aspect, the at least one communicative method is any of a SPI; a USART; a UART; a USB; a SDIO; a I2C; or a I2S. in an aspect, the integrated circuit is communicatively can be coupled to at least one processor. In another aspect, the integrated circuit can be configured to control flow of at least one hardware servicing component.

In an aspect, the flow can be at least one of a data flow; a power flow; a clock signal flow; or an electrical signal flow. In an aspect, the flow can be at least one of a data flow; a power flow; a clock signal flow; or an electrical signal flow.

In an aspect, the gating method can be at least one of a logic gate; a power gate; a switch; an electronic gate; a DC gate signal; an AC gate signal; a pulsed gate signal; a trigger current; a trigger voltage; or a logical instruction.

In an aspect, the change to metric value comprises at least one of a power usage; a data usage; or a price per usage.

In an aspect, the PCD stores the result of the last subscription verification request to the subscription server.

In an aspect, the present disclosure relates to a method of dynamically controlling access to hardware servicing components based on the subscription status, said method comprising a portable communicative device (PCD) with at least one processor loaded with instructions; at least one step to enroll into a subscription plan consisting of a set of features; at least one step of controlling access to a specific hardware servicing component and a price is associated with each subscription plan based on the usage; a step of identifying the subscription status for a given portable communicative device (PCD) based on a unique identifier by querying the subscription server using the unique identifier; and a step of dynamically controlling flow by at least one gating method to a specific hardware servicing component depending on the subscription status and features resulting in a change to at least one metric value.

In an aspect, the set of instructions loaded in the processor comprises at least one of high level language instructions; Low level language instructions; binary instructions; machine understandable instructions; assembly instructions; and interactive instructions.

In an aspect, the step of enrolling into a subscription plan comprises at least one of an application accessible from an electronic device; a written note; a verbal note; or an interactive instructions.

In an aspect, the method of controlling access to the hardware servicing component comprises at least one of a software application loaded in the processor; a hardware circuit; or a subscription enabler integrated circuit. In an aspect, the method of identifying the subscription status from a subscription server comprises at least one of a web service call to a subscription server; a read from an addressable memory space; a data exchange with storage; or a method of reading the status of the controllable switches.

In an aspect, the method of controlling the flow through gating method comprises at least one of a logic gate; a power gate; a switch; an electronic gate; a DC gate signal; an AC gate signal; a pulsed gate signal; a trigger current; a trigger voltage; or a logical instruction.

The present disclosure further relates to a subscription enabler integrated circuit (SBIC) to dynamically control access to hardware servicing components comprising of a memory; a register operatively coupled with processor; communicatively coupled with hardware service access components through at least one more communicative methods; communicatively coupled with subscription server; provisioned to receive the subscription status from a subscription server by querying based on a unique identifier; provisioned through instructions to control the flow to at least one hardware servicing component through at least one gating method resulting in a change to at least one metric.

In an aspect, the hardware servicing components includes any or a combination of fall detection, a heart rate, a pulse rate, a body temperature, a blood sugar, a breath rate, emergency call, modem, GPS, 9-axis accelerometer, magnetometer, UV sensor, temperature sensor, fuel gauge sensor, shock sensor, humidity sensor, proximity sensor, CO₂ sensor and barometer.

In an aspect, the communicative methods of communicating with the hardware servicing components comprise at least one of a SPI; a USART; a UART; a USB; a SDIO; a I2C; or a I2S.

In an aspect, the subscription server can be communicatively coupled with the SBIC by at least one of a short range communication; a long range communication; a wired communication; a wireless communication; or data communication.

In an aspect, the unique identifier can be selected from at least one of a IMEI (International Mobile Equipment Identify Number); a MEID (Mobile Equipment Identifier); a unique number stored in the memory of an integrated circuit; a hardcoded number in the application program; an unique number that is assigned at the time of the registration.

In an aspect, the flow can be selected from at least one of data flow; power flow; clock signal flow; and electric signal flow.

In another aspect, the gating method is selected from at least one of a logic gate; a power gate; a switch; an electronic gate; a DC gate signal; an AC gate signal; a pulsed gate signal; a trigger current; a trigger voltage; or a logical instruction.

In an aspect, the metric value comprises at least one of a power usage; a data usage; or a price per usage.

In an aspect, the SBIC can store the latest subscription status received from the subscription server.

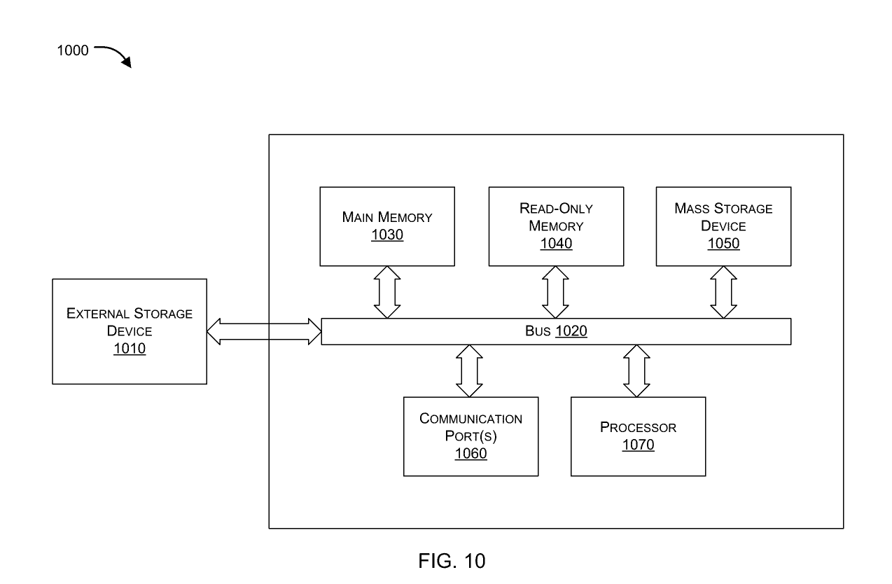

FIG. 10 illustrates an exemplary computer system in which or with which embodiments of the present invention may be utilized in accordance with embodiments of the present disclosure.

In an embodiment, the computer system 1000 can perform the web page classification based on noise removal. Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware. As shown in the figure, computer system 800 includes an external storage device 1010, a bus 1020, a main memory 1030, a read only memory 1040, a mass storage device 1050, communication port 1060, and a processor 1070. A person skilled in the art will appreciate that computer system 1000 may include more than one processor and communication ports. Examples of processor 1070 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 1070 may include various modules associated with embodiments of the present invention. Communication port 1060 can be any of an RS-232 port for use with a modem based dialup connection, a 10/100 Ethernet port, a Gigabit or 10 Gigabit port using copper or fiber, a serial port, a parallel port, or other existing or future ports. Communication port 1060 may be chosen depending on a network, such a Local Area Network (LAN), Wide Area Network (WAN), or any network to which computer system 1000 connects. Memory 1030 can be Random Access Memory (RAM), or any other dynamic storage device commonly known in the art. Read only memory 1040 can be any static storage device(s) e.g., but not limited to, a Programmable Read Only Memory (PROM) chips for storing static information e.g., start-up or BIOS instructions for processor 1070. Mass storage 1050 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc. Bus 1020 communicatively couples processor(s) 1070 with the other memory, storage and communication blocks. Bus 1020 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 1070 to software system. Optionally, operator and administrative interfaces, e.g. a display, keyboard, and a cursor control device, may also be coupled to bus 1020 to support direct operator interaction with computer system 800. Other operator and administrative interfaces can be provided through network connections connected through communication port 1060. External storage device 1010 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

In the foregoing description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, to avoid obscuring the present invention.

Some portions of the detailed description have been presented in terms of algorithms and symbolic representations of operations on data bits within a computer memory. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “computing”, “comparing”, “determining”, “adjusting”, “applying”, “creating”, “ranking,” “classifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Certain embodiments of the present invention also relate to an apparatus for performing the operations herein. This apparatus may be constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Many other embodiments will be apparent to those of skill in the art upon reading and understanding the above description. The scope of the invention should therefore be determined with reference to the appended claims, along with the full scope of equivalents to which such claims are entitled.

We claim:

1. A system comprising:
(a) one or more portable communication devices (PCDs); and
(b) a subscription level server operably coupled to the one or more PCDs, wherein each (PCD) comprises:
one or more selectably actuable hardware servicing components and/or one or more sensors;
a non-transitory storage device having embodied therein one or more routines operable to facilitate accessing and processing at least one subscription level; and
one or more processors coupled to the non-transitory storage device and operable to execute the one or more routines so as to manipulate one or more registers during the execution, wherein the one or more routines include:
a subscription plan receiving module, which when executed by the one or more processors, receives, at the PCD, from the subscription level server, a subscription plan corresponding to the PCD; and
a subscription plan processing module, which when executed by the one or more processors, activates the one or more hardware servicing components and/or sensors based on the received subscription plan so as to dynamically control flow to the one or more hardware servicing components by at least one gating method, wherein the portable computing device is an electronic device selected from the group consisting of a mobile computing device and a user wearable device.

2. The system of claim 1, wherein the one or more routines further include a unique identifier transmission module, which when executed by the one or more processors, transmits a unique identifier (UID) of the PCD to the server, in response to which the server returns the subscription plan to the PCD.

3. The system of claim 1, wherein the UID is International Mobile Equipment Identity (IMEI) number or MEID (Mobile Equipment Identifier) of the PCD.

4. The system of claim 1, wherein the received subscription plan is an executable file that is executed by the PCD to activate the one or more hardware components and/or sensors at the PCD.

5. The system of claim 1, wherein the server stores a plurality of subscription plans, each plan having a defined number of hardware components and/or sensors that are to be activated as part of the respective plan such that when a user selects the subscription plan, the one or more hardware components and/or sensors that form part of the selected subscription plan are activated at firmware level.

6. The system of claim 5, wherein the firmware level activation of the one or more hardware components and/or sensors disallows manual activation/deactivation of the one or more hardware components and/or sensors through interface of the PCD.

7. The system of claim 5, wherein the firmware level activation of the one or more hardware components and/or sensors deactives other hardware components and/or sensors that do not form part of the subscription plan.

8. The system of claim 5, wherein the subscription plan is selectable through the PCD or another computing device selected from any of a laptop, a PC, a mobile phone, a smart phone, a smart watch, a PDA, and a touch interface-based computing device.

9. The system of claim 1, wherein the PCD is any or a combination of a mobile phone, a smart phone, a tablet PC, a PDA, a smart watch, a fitness tracker, a wearable computing device, and a touch interface-based computing device.

10. The system of claim 1, wherein the one or more hardware components and/or sensors are selected from any or a combination of a fall detection sector, a heart rate detector, a pulse rate detector, a body temperature sensor, a blood sugar detection sensor, a breath rate sensor, emergency call detector, a modem, a GPS, a 9-axis accelerometer, a magnetometer, a health-attribute measurement sensor, a PCD feature enabling hardware component, a UV sensor, a humidity sensor, a proximity sensor, a CO₂ sensor, and a barometer.

11. The system of claim 1, wherein the subscription plan is switched to a second subscription plan by user of the PCD such that the second subscription plan is received by the PCD in real-time or after an update request is sent by the PCD at periodic/defined intervals, and wherein based on the received second subscription plan, corresponding hardware components and/or sensors are activated and others are deactivated.

12. The system of claim 1, wherein the subscription plan is stored locally on the PCD such that if, upon restart or during operation, the PCD is not able to reach the server, the locally stored subscription plan is used for activation/deactivation of the one or more hardware components and/or sensors.

13. The system of claim 1, wherein, upon activation of the one or more hardware components and/or sensors, user of the PCD is enabled to configure one or more parameters of the activated hardware components and/or sensors through interface of the PCD.

14. The system of claim 1, wherein the PCD is configured such that hardware components and/or sensors that are not activated as part of the subscription plan cannot be activated through interface of the PCD.

15. The system of claim 1, wherein the flow is controlled through any or a combination of a software application loaded in the processor; a hardware circuit; and a subscription enabler integrated circuit.

16. The system of claim 15, wherein the integrated circuit is communicatively coupled to at least one hardware servicing component through at least one communicative method.

17. The system of claim 16, wherein the at least one communicative method is any of a SPI; a USART; a UART; a USB; a SDIO; a I2C; and a I2S.

18. The system of claim 15, wherein the integrated circuit is controls flow of at least one hardware servicing component.

19. The system of claim 1, wherein the flow is at least one of a data flow; a power flow; a clock signal flow; an electrical signal flow.

20. The system of claim 1, wherein the gating method can be at least one of a logic gate; a power gate; a switch; an electronic gate; a DC gate signal; a AC gate signal; a pulsed gate signal;
a trigger current; a trigger voltage; a logical instruction.

21. A method for accessing and processing at least one subscription level at a portable communication device (PCD), said method comprising the steps of:
receiving, at the PCD, from a subscription level server that is operatively coupled with one or more PCDs, a subscription plan corresponding to the PCD, wherein the PCD comprises one or more selectably actuable hardware servicing components and comprises a non-transitory storage device having embodied therein one or more routines operable to facilitate accessing and processing at least one subscription level, and comprises one or more processors coupled to the non-transitory storage device and operable to execute the one or more routines so as to manipulate one or more registers during the execution; and
activating, at the PCD, the one or more hardware servicing components based on the received subscription plan so as to dynamically control flow to the one or more hardware servicing components by at least one gating method, wherein the portable computing device is an electronic device selected from the group consisting of a mobile computing device and a user wearable device.

22. The method of claim 21, said method further comprising the step of transmitting a unique identifier (UID) of the PCD to the server, in response to which the server returns back the subscription plan to the PCD.

23. The method of claim 22, wherein the UID is any or a combination of IMEI (International Mobile Equipment Identify Number) of the PCD; a MEID (Mobile Equipment Identifier) of the PCD, a unique number stored in memory of an integrated circuit of the PCD; a hardcoded number in an application program; and a unique identifier assigned at the time of registration of the PCD.

24. The method of claim 22, wherein the unique identifier represents at least one of duration of the subscription plan; age of the subscriber; location of the subscriber; type of the PCD; and
the model of the PCD.

25. The method of claim 21, wherein the received subscription plan is an executable file that is executed by the PCD to activate the one or more hardware components and/or sensors at the PCD.

26. The method of claim 21, wherein the server stores a plurality of subscription plans, each plan having a defined number of hardware components and/or sensors that are to be activated as part of the respective plan such that when a user selects the subscription plan, the one or more hardware components and/or sensors that form part of the selected subscription plan are activated at firmware level.

27. The method of claim 21, wherein the subscription plan is selectable through the PCD or another computing device selected from any of a laptop, a PC, a mobile phone, a smart phone, a smart watch, a PDA, and a touch interface-based computing device.

28. The method of claim 15, wherein the PCD is any or a combination of a mobile phone, a smart phone, a tablet PC, a PDA, a smart watch, a wearable computing device, and a touch interface-based computing device.

29. The method of claim 21, wherein price for each subscription plan is either a fixed price irrespective of usage for a period of time or an adjusted price based on the usage for a period of time.

30. The method of claim 21, wherein the server is any or a combination of a web server; an application loaded inside the PCD; an addressable memory space inside an integrated circuit; or a pair of switches to toggle.
